(19) United States
(12) Patent Application Publication
(10) Pub. No.: US 2007/0209490 A1
(43) Pub. Date: Sep. 13, 2007

(54) Multi slicer

(76) Inventor: Deb Gehlhausen, Redford, MI (US)

Correspondence Address: Deb Gehlhausen, 18658 Sumner Rd, Redford, MI, 48240, US

(21) Appl. No.: 11/373,651

(22) Filed: Mar. 13, 2006

(51) Int. Cl. B26D 1/00

(52) U.S. Cl. 83/13

(57) ABSTRACT

A Multi slicer comprised of 1 handle pressing mechanism 2 adjustable blade apparatus 3 hinging mechanism 4 blade locking mechanism 5 platform apparatus.

### CROSS-REFERENCE TO RELATED APPLICATIONS

This application relates to and claims priority from U.S. Provisional Patent Application Ser. No. 60/659,567 filed on Mar. 09, 2005, specifications which are incorporated herein by reference.

### FEDERALLY SPONSORED RESEARCH

Not Applicable

### SEQUENCE LISTING OR PROGRAM

Not Applicable

### BACKGROUND OF THE INVENTION

This invention relates to a more ergonomically correct slicing apparatus used in the culinary industry, specifically for the for the use of reducing the use of muscles while slicing objects with hard said properties.

### BACKGROUND OF INVENTION—FIELD OF INVENTION

In standard culinary practices in the commercial industry, as well as the home use setting have relied on many different way of slicing perishable items. The equipment used is usually a sharp knife or cutting device or a wired cheese cutting type of tool apparatus. All of the above stated require bruit strength to operate and perform the cutting of the perishable item. Furthermore, the way of slicing perishable items w/ a knife can cause injury to the end user, by way of being cut by the sharp blade. To add, with the old way of slicing perishable items takes time for set up in lieu of a cutting board. To add, the perishable item is not uniformly sliced, there in no constant width to the slicing of the perishable item.

(a) The end user has a more greater chance of laceration injury with the old method.

(b) The end user has a more greater chance of muscle strain injury with the old method.

(c) The end user has a more greater chance of time restraints by way of setting up the perishable item to be sliced.

(d) the end user has a more greater chance of non uniform slices by way of no constant locking mechanism allowing for desired width.

### BACKGROUND OF INVENTION—OBJECTS AND ADVANTAGES

Accordingly besides the objects and advantages of the Multi slicer described in my above patent, several objects and advantages of the present invention are:

(a) The end user has a less greater chance of laceration injury with the Multi slicer.

(b) The end user has a less greater chance of muscle strain injury with the Multi Slicer.

(c) The end user has a less greater chance of time restraints by way of not setting up the perishable item to be sliced but instead by placing the item in the multi slicer

(d) The end user has a less greater chance of non uniform slices by way of having constant locking mechanism allowing for desired width.

### SUMMARY

In accordance with the present invention, is comprised of a hinging mechanism, blade locking mechanism, adjustable blade apparatus, platform apparatus and handle pressing mechanism.

### DRAWINGS—FIGURES

In drawings, close related figures have same number but different alphabetical suffixes.

Drawings—Figures

FIGS. 1 (1) through 1 (5) illustrates various aspects of the Multi slicer in a closed position with all comprising components.

FIGS. 2 (1) through 2 (5) illustrates various aspects of the Multi Slicer in a open position with all comprising components.

FIGS. 3 (1) through 3 (5) illustrates various aspects of the Multi Slicer in a front open position with all comprising components.

### DRAWINGS—REFERENCE NUMERALS

1 Handle pressing mechanism 2 Adjustable blade apparatus

3 Hinging Mechanism 4 Blade locking mechanism

5 Platform apparatus

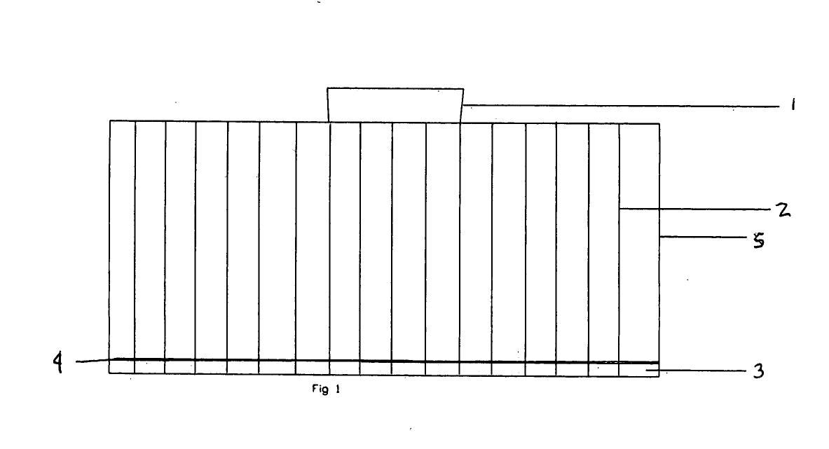

Detailed Description—FIGS. 1(1) through 1(5), 2(1) through 2(5) and 3(1) through 3(5)

A preferred embodiment of the present invention is illustrated in FIG. 1(1) (top view) the Multi Slicer has 1 handle pressing mechanism is attached to outer portion of the Multi Slicer 2 adjustable blade apparatus is connected to the inner portion of the Multi Slicer 4 blade locking mechanism is attached to 2 adjustable blade apparatus 3 hinging mechanism is attached to 1 as well as 5 platform apparatus.

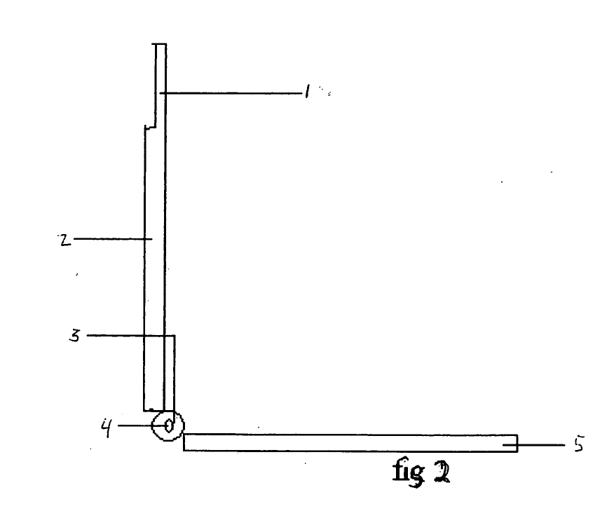

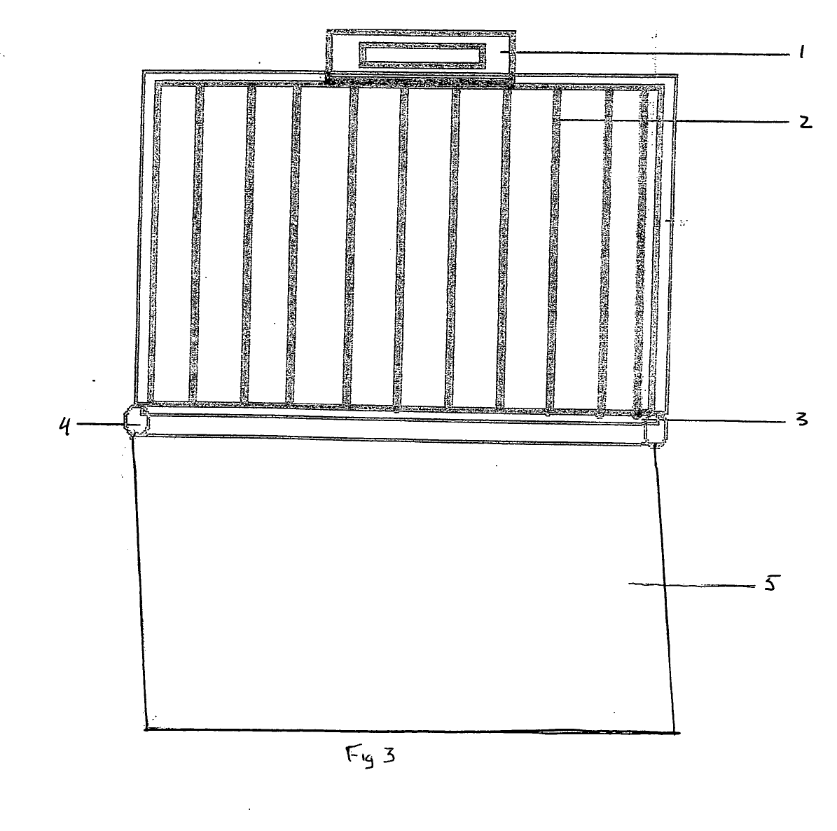

Operation—FIGS. 1-3

The manner of using the Multi Slicer 1 depressing the handle pressing mechanism which 3 hinging mechanism allows the end user to slice through the perishable item 2 adjustable blade apparatus slices through the perishable item which is placed on 5 platform apparatus 4 blade locking mechanism allows for the end user to manipulate the desired width of the slices of the perishable item.

Advantages

From the description above a number of advantages of my multi slicer become clear and evident.

(a) With this product people will have a less chance of laceration injury.

(b) My product will help reduce muscle strain from cutting hard perishable items.

(c) My product will also increase production by way of less set up time.

(d) My product will give you a desired uniform slice every time with the adjustable blades.

### CONCLUSION, RAMIFICATIONS, AND SCOPE

Accordingly the reader will see that the Multi Slicer will become a revolution in the culinary industry as well as home use. The Multi slicer product is user friendly and easy for anyone to use. Furthermore, the reader will see how great it will be to be able to slice through an entire block of cheese in seconds. To add, the Multi Slicer has more advantages in that
It permits the end user to do multiple slicing in one movement.
The end user will no longer have to try and make uniform slices.
The use of the Multi Slicer will cut down on cutting boards cluttering kitchens.
The use of the Multi Slicer in the commercial industry should cut down on workers compensation cases due in part to laceration injuries.

Although the description above contains outlines many specifications it should not be mis interpreted to limiting the scope of the invention. But as merely providing illustrations of some of the presently preferred embodiments of this invention For example the Multi Slicer can be shaped differently then rectangularly, the Multi slicer could have different radius.

We claim:

1. A method for uniformly, simultaneously slicing perishable items in multiple slices in one lowering movement of the “multi Slicer” movement
(i) Handle pressing mechanism
(ii) Adjustable blade apparatus
(iii) Hinging Mechanism
(iv) Blade locking mechanism
(v) Platform apparatus
